(19) United States
(12) Patent Application Publication
(10) Pub. No.: US 2020/0292719 A1
(43) Pub. Date: Sep. 17, 2020

(54) RADIATION DETECTOR

(71) Applicants: Board of Regents, The University of Texas System, Austin, TX (US); Nanoholdings LLC, Rowayton, CT (US)

(72) Inventors: Manuel Quevedo-Lopez, Richardson, TX (US); Jesus I. Mejia Silva, Richardson, TX (US); Bhabendra K. Pradhan, Rowayton, CT (US); Bruce E. Gnade, Lewisville, TX (US)

(21) Appl. No.: 16/086,231

(22) PCT Filed: Mar. 17, 2017
(86) PCT No.: PCT/US2017/022893

§ 371 Date: Sep. 18, 2018

Related U.S. Application Data
(60) Provisional application No. 62/310,338, filed on Mar. 18, 2016.

(51) Int. Cl. G01T 1/20; G01T 1/24

(52) U.S. Cl. CPC G01T 1/2018; G01T 1/247; G01T 1/243

(57) ABSTRACT

A system for detecting radiations includes an array of detectors for receiving the radiations and an integrated circuit (IC). Each detector detects a specific type of radiation and generates a corresponding detector output signal. The IC receives the corresponding detector output signal from each detector and generates an output signal that is indicative of detecting the radiations. The array of detectors is implemented using at least one of a silicon technology and a thin film technology. The IC is implemented using at least one of a complementary metal oxide semiconductor (CMOS) technology and the thin film technology.

### CROSS REFERENCE TO RELATED APPLICATION

This application claims the benefit of U.S. Provisional Application Ser. No. 62/310,338, filed Mar. 18, 2016, the disclosure of which is hereby incorporated by reference in its entirety, including any figures, tables, and drawings.

### BACKGROUND OF THE INVENTION

The present invention generally relates to radiation detectors, and, more particularly, to a hand-held radiation detector for simultaneously detecting multiple radiations.

Radiation detectors are utilized to detect multiple radiations such as alpha particles, beta particles, gamma rays, X-rays, and neutron particles. Conventional hand-held radiation detectors are generally deployed in security areas such as airports, border protection, and the like. One technique of detecting neutron particles generally includes a Helium-3 (He3+) tube. Since He3+ is a rare isotope of helium, it is not widely available. Thus, He3+ is produced through the decay of tritium. However, the production of He3+ through the decay of tritium is a very slow process, thereby limiting the scope of its usage in the above-mentioned applications. Moreover, He3+ tube cannot be used for detecting radiations other than neutron particles.

Further, the radiations detected by the radiation detectors need to be processed, identified, and displayed to a user. However, the conventional radiation detectors do not include electronic circuits for interfacing the radiation detectors with smartphones or personal computers. Hence, systems that include the radiation detectors, further include processing systems and display units for processing and displaying the detected radiations, respectively. This results in an increase in the overall cost of the system.

Alternate techniques of detecting radiations include the use of systems such as photomultiplier tubes, air ionization chambers, and Geiger-Muller counters. However, the aforementioned systems result in an increase in the overall cost, area, and weight of the radiation detectors. Further, the power required for operating these systems is very high.

Yet another technique to build amplifiers for radiation detectors is the use of circuits based on JFET and bipolar transistors. Such circuits are complex to design and require high operational voltages. Further, these circuits are typically used in radiation detectors to detect a single radiation, e.g., neutron particles, and are difficult to integrate on a single integrated circuit for detecting multiple radiations.

### BRIEF SUMMARY OF THE INVENTION

Embodiments of the subject invention provide novel and advantageous systems and methods for detecting radiation. A device can include an array of detectors for receiving the radiation, which may include multiple types of radiation, and an integrated circuit (IC). Each detector detects a specific type of radiation and generates a corresponding detector output signal. The IC receives the corresponding detector output signal from each detector and generates an output signal that is indicative of detecting the radiation. The array of detectors can be implemented using silicon technology, thin film technology, or both. The IC can be implemented using complementary metal oxide semiconductor (CMOS) technology, thin film technology, or both.

### BRIEF DESCRIPTION OF THE DRAWINGS

The following detailed description of the preferred embodiments of the present invention will be better understood when read in conjunction with the appended drawings. The present invention is illustrated by way of example, and not limited by the accompanying figures, in which like references indicate similar elements.

FIG. 1 is a schematic block diagram of a radiation detector in accordance with an embodiment of the present invention;

FIG. 2 is a schematic circuit diagram of a sensor, a preamplifier, and a signal shaping circuit of the radiation detector of FIG. 1 in accordance with an embodiment of the present invention;

FIG. 3 is a schematic circuit diagram of the sensor, the preamplifier, and the signal shaping circuit of the radiation detector of FIG. 1 in accordance with another embodiment of the present invention;

FIG. 4 is a schematic circuit diagram of the preamplifier of the radiation detector of FIG. 1 in accordance with another embodiment of the present invention;

FIGS. 5A and 5B are front and rear views of the radiation detector of FIG. 1 in accordance with an embodiment of the present invention;

FIG. 6 is a perspective view of the radiation detector of FIG. 1 including a reflector in accordance with another embodiment of the present invention; and

FIG. 7 is a perspective view of the radiation detector of FIG. 1 in accordance with another embodiment of the present invention.

### DETAILED DESCRIPTION

The detailed description of the appended drawings is intended as a description of the currently preferred embodiments of the present invention, and is not intended to represent the only form in which the present invention may be practiced. It is to be understood that the same or equivalent functions may be accomplished by different embodiments that are intended to be encompassed within the spirit and scope of the present invention.

An object of the present invention is to provide a radiation detector for detecting radiations.

It would be advantageous to have a radiation detector that simultaneously detects multiple radiations, has a simple design, provides high resolution, and that overcomes the problems of the conventional radiation detectors discussed in the Background section. Thus, it is also an object of the present invention to provide such a radiation detector.

An embodiment of the present invention provides a radiation detector for detecting multiple radiations such as alpha particles, beta particles, gamma rays, X-rays, and neutron particles. The radiation detector includes an array of detectors and an integrated circuit (IC). The array of detectors receives the multiple radiations and generates corresponding multiple detector output signals. The IC is connected to the array of detectors for receiving the detector output signals and generates an output signal that is indicative of detecting a radiation. Further, the array of detectors is implemented using at least one of a silicon technology and a thin film technology and the IC is implemented using at least one of a complementary metal oxide semiconductor (CMOS) technology and the thin film technology.

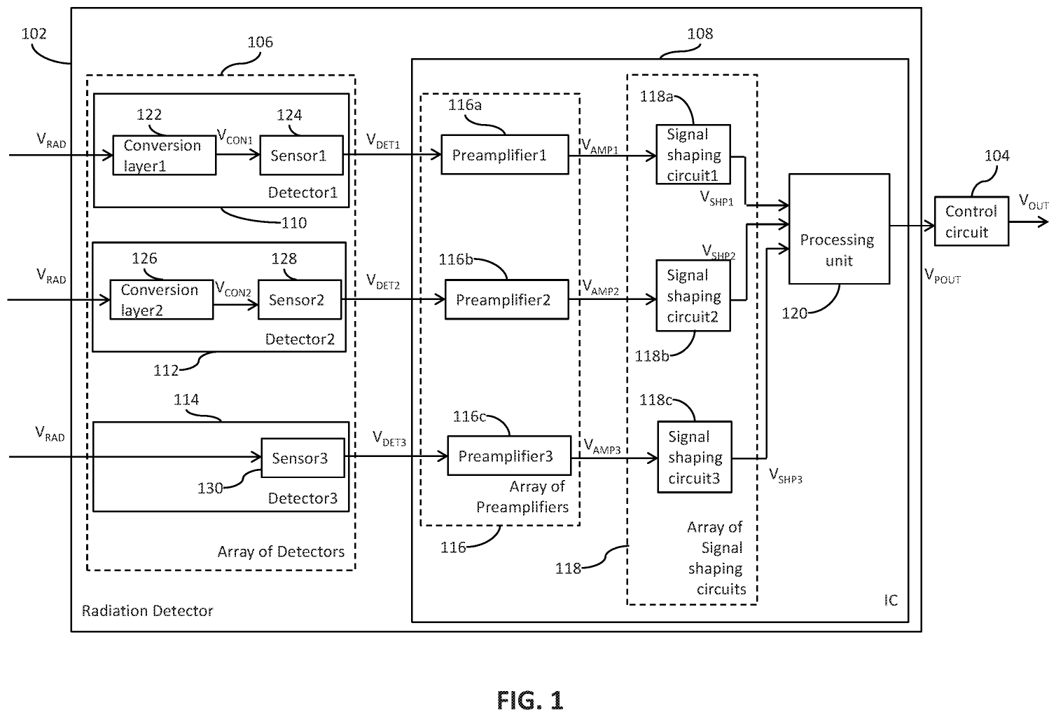

Referring now to FIG. 1, a schematic block diagram of a radiation detector 102 connected to a control circuit 104 in accordance with an embodiment of the present invention is shown. The radiation detector 102 detects multiple radiations such as alpha rays, beta rays, gamma rays, X-rays, and neutron particles. The radiation detector 102 includes an array of detectors 106 and an integrated circuit (IC) 108. In an embodiment, the array of detectors 106 is implemented using silicon technology, and the IC 108 is implemented using complementary metal oxide semiconductor (CMOS) technology. In another embodiment, the array of detectors 106 and the IC 108 are implemented using a thin film technology. Because the array of detectors 106 includes multiple detectors, the radiation detector 102 provides an interchangeable pixelated array of detectors 106 to detect the multiple radiations or types of radiation.

The array of detectors 106 includes first through third detectors 110-114. The IC 108 includes an array of preamplifiers 116, an array of signal shaping circuits 118, and a processing unit 120. The array of preamplifiers 116 includes first through third preamplifiers 116a-116c. The array of signal shaping circuits 118 includes first through third signal shaping circuits 118a-118c. In an embodiment, when the radiation detector 102 is configured to detect a single type of the radiation, the processing unit 120 includes an OR logic gate. The OR logic gate may include a NOR logic gate. In another embodiment, when the radiation detector 102 is configured to detect multiple radiations or types of radiation, the processing unit 120 includes a microcontroller or a digital signal processor.

The array of detectors 106 receives multiple radiations or types of radiation including first through third radiations or types of radiation. The first through third detectors 110-114 detect the first through third (types of) radiation(s), respectively. In an embodiment, the first (type of) radiation is a neutron radiation, the second (type of) radiation is either a gamma ray or an X-ray, and the third (type of) radiation is one of an alpha ray or a beta ray.

The first detector 110 that detects neutron radiations includes a first conversion layer 122 and a first sensor 124. The first conversion layer 122 includes nanoparticles of neutron sensitive materials such as Boron (¹⁰B) and Gadolinium (¹⁵⁷Gd) in their carbide, oxide, nitride, and metallic forms. The first conversion layer 122 receives the multiple radiations and generates corresponding ionizing radiations. The ionizing radiations (hereinafter referred to as “first conversion output signal V_{CON1}”) include at least one of beta particles, gamma rays, and alpha particles. The first sensor 124 is a charge sensor and includes either a PN diode or a PIN diode.

When the first detector 110 receives the multiple radiations, the first conversion layer 122 generates the first conversion output signal V_{CON1} corresponding to the first radiation. The first sensor 124, which is connected to the first conversion layer 122, receives the first conversion output signal V_{CON1} and generates a first detector signal V_{DET1}.

The second detector 112 that detects at least one of gamma rays or X-rays includes a second conversion layer 126 and a second sensor 128. The second conversion layer 126 is either a gamma scintillator or an X-ray scintillator. The second conversion layer 126 includes either sodium iodide doped with thallium NaI(TI), Cesium iodide doped with thallium CsI(TI), sodium activated cesium iodide CsI(Na), or anthracene. The second sensor 128 is a charge sensor and includes either a PN diode or a PIN diode.

When the second detector 112 receives the multiple radiations, the second conversion layer 126 generates a second conversion output signal V_{CON2} corresponding to the second radiation. The second sensor 128 that is connected to the second conversion layer 126 receives the second conversion output signal V_{CON2} and generates a second detector signal V_{DET2}.

The third detector 114 includes a third sensor 130 which is a photon-sensitive sensor. The third sensor 130 includes either a photosensor or a photoconductor. When the third detector 114 receives the multiple radiations, the third sensor 130 generates a third detector signal V_{DET3} corresponding to the third radiation.

The first through third preamplifiers 116a-116c are connected to the first through third sensors 124, 128, and 130, respectively, for receiving the first through third detector signals V_{DET1}-V_{DET3} and generating first through third amplified detector signals V_{AMP1}-V_{AMP3}, respectively. The first through third signal shaping circuits 118a-118c are connected to the first through third preamplifiers 116a-116c, respectively, for receiving the first through third amplified detector signals V_{AMP1}-V_{AMP3} and generating first through third shaped detector signals V_{SHP1}-V_{SHP3}, respectively.

The processing unit 120 is connected to the first through third signal shaping circuits 118a-118c for receiving the first through third shaped detector signals V_{SHP1}-V_{SHP3}, and generating a processed output signal V_{POUT}. The processed output signal V_{POUT} is generated based on logic states of the first through third shaped detector signals V_{SHP1}-V_{SHP3}.

The control circuit 104 is connected to the processing unit 120 for receiving the processed output signal V_{POUT} and generating an output signal V_{OUT}. The control circuit 104 acts as an interface between the radiation detector 102 and at least one of smartphones, tablets, personal computers, and laptops. The smartphones, tablets, personal computers, and laptops further process the output signal V_{OUT} to identify the incident radiation. Further, these devices provide a graphical representation of the incident radiation V_{RAD}.

In another embodiment, the processing unit 120 includes a multichannel analyzer (MCA) (not shown). The MCA identifies the type of radiation V_{RAD} based on the first through third shaped detector signals V_{SHP1}-V_{SHP3}.

In an embodiment, the radiation detector 102 and the control circuit 104 are included on a single substrate. In another embodiment, the radiation detector 102 and the control circuit 104 are included on different substrates. In an embodiment, the substrate is a silicon substrate. In another embodiment, the substrate is either glass or plastic. Further, the array of preamplifiers 116 and the array of signal shaping circuits 118 can be implemented using either a poly-silicon, oxide-based semiconductors, or amorphous silicon thin film electronic devices.

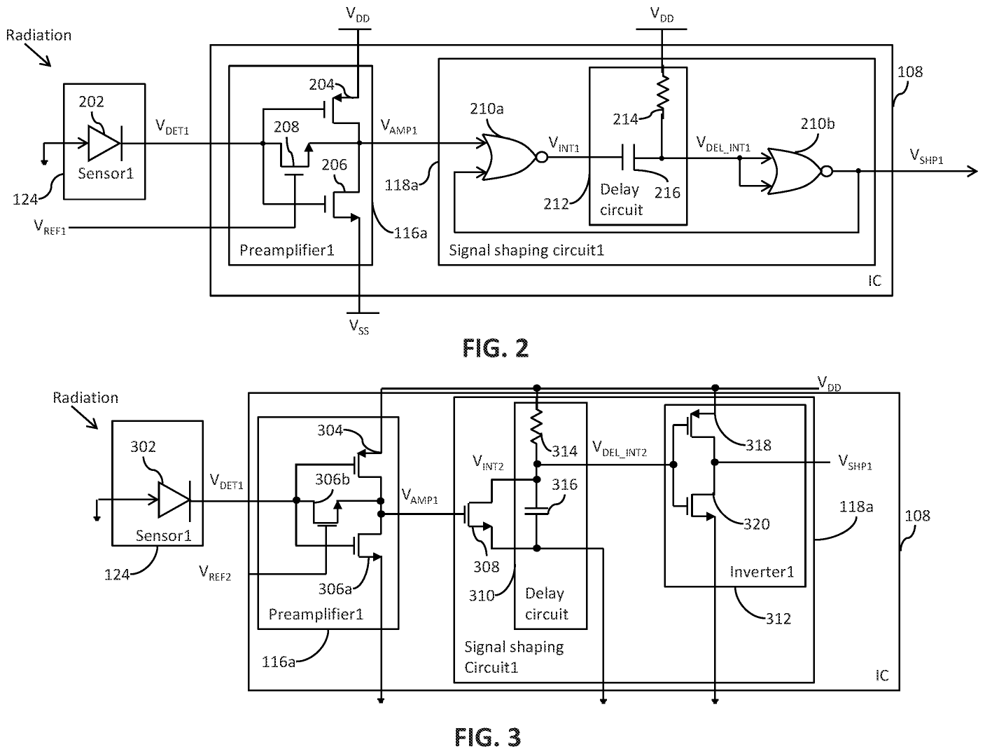

Referring now to FIG. 2, a schematic circuit diagram of the radiation detector 102 in accordance with an embodiment of the present invention is shown. Further, the first detector 124 is implemented using the silicon technology, and the IC 108 is implemented using the CMOS technology. For illustrative purpose, FIG. 2 shows the first sensor 124, the first preamplifier 116a, and the first signal shaping circuit 118a. It will be well understood to a person skilled in the art that the second and third preamplifiers 116b and 116c are structurally and functionally similar to the first preamplifier 116a and the second and third signal shaping circuits 118b and 118c are structurally and functionally similar to the first signal shaping circuit 118a.

The first sensor 124 includes a first diode 202. The first preamplifier 116a includes first through third transistors 204, 206, 208. In an embodiment, the first transistor 204 is a p-channel MOS (PMOS) transistor, and the second and third transistors 206 and 208 are n-channel MOS (NMOS) transistors. The first signal shaping circuit 118a includes first and second logic gates 210a and 210b and a delay circuit 212. In an embodiment, the first and second logic gates 210a and 210b are NOR logic gates. The delay circuit 212 includes a resistor 214 and a capacitor 216.

When the first detector 110 detects the first radiation, the first conversion layer 122 generates the first conversion output signal V_{com} corresponding to the first radiation. The first sensor 124 receives the first conversion output signal V_{CON1} and generates the first detector signal V_{DET1}.

A source terminal of the first transistor 204 is connected to a supply voltage V_{DD}. A gate terminal of the first transistor 204 is connected to the first diode 202 for receiving the first detector signal V_{DET1}. A drain terminal of the second transistor 206 is connected to a drain terminal of the first transistor 204 to generate the first amplified detector signal V_{AMP1}. A gate terminal of the second transistor 206 is connected to the first diode 202 for receiving the first detector signal V_{DET1} and a source terminal thereof is connected to a supply voltage V_{SS}. A source terminal of the third transistor 208 is connected to the drain terminal of the first transistor 204 and a drain terminal of the third transistor 208 is connected to the gate terminal of the first transistor 204. A gate terminal of the third transistor 208 receives a first reference voltage signal V_{REF1}.

The first logic gate 210a has a first input terminal connected to the drain of the first transistor 204 for receiving the first amplified detector signal V_{AMP1} and a second input terminal for receiving the first shaped detector signal V_{SHP1}. The first logic gate 210a has an output terminal for generating a first intermediate signal V_{INT1}. A first terminal of the capacitor 216 is connected to the output terminal of the first logic gate 210a for receiving the first intermediate signal V_{INT1}. A first end of the resistor 214 is connected to the supply voltage V_{DD}, and a second end of the resistor 214 is connected to a second terminal of the capacitor 216 for generating a delayed version of the first intermediate signal (hereinafter referred to as “delayed first intermediate signal”) V_{DEL_INT1}. First and second input terminals of the second logic gate 210b are connected to the delay circuit 212 for receiving the delayed first intermediate signal V_{DEL_INT1}. The second logic gate 210b has an output terminal for generating the first shaped detector signal V_{SHP1}.

In operation, when the first detector 110 receives the first radiation, the diode 202 activates the first detector signal V_{DET1}. Thus, the first preamplifier 116a receives the first detector signal V_{DET1}, and amplifies and inverts the first detector signal V_{DET1}. Further, the first preamplifier 116a activates the first amplified detector signal V_{AMP1}. The first logic gate 210a receives the activated first amplified detector signal V_{AMP1} and the first shaped detector signal V_{SHP1} at logic low state and generates the first intermediate signal V_{SHP1} at logic low state. The capacitor 216 receives the first intermediate signal V_{INT1} at logic low state and starts discharging to ground. Thus, the delay circuit 212 generates the delayed first intermediate signal V_{DEL_INT1} at logic low state. The second logic gate 210b receives the delayed first intermediate signal V_{DEL_INT1} at logic low state and generates the first shaped detector signal V_{SHP1} at logic high state. The first shaped detector signal V_{SHP1} at logic high state indicates that the radiation detector 102 has detected the first radiation. The time period for which the first shaped detector signal V_{SHP1} remains high depends on the discharging rate of the capacitor 216. After the time period has elapsed, the delay circuit 212 generates the delayed first intermediate signal V_{DEL_INT1} at a voltage level that is greater than a threshold voltage of the second logic gate 210b. Thus, the second logic gate 210b generates the first shaped detector signal V_{SHP1} at logic low state.

It will be apparent to a person skilled in the art that the second signal shaping circuit 118b generates the second shaped detector signal V_{SHP2} at logic high state when the radiation detector 102 receives the second radiation and the third signal shaping circuit 118c generates the third shaped detector signal V_{SHP3} at logic high state when the radiation detector 102 receives the third radiation.

Referring now to FIG. 3, a schematic circuit diagram of the radiation detector 102 implemented in the thin film technology in accordance with another embodiment of the present invention is shown. For illustrative purpose, FIG. 3 shows the first sensor 124, the first preamplifier 116a, and the first signal shaping circuit 118a. The first sensor 124 includes a second diode 302. The first preamplifier 116a includes a first thin film transistor 304 and second and third thin film transistors 306a and 306b. The first signal shaping circuit 118a includes a fourth thin film transistor 308, a delay circuit 310, and a first thin film inverter 312. The first thin film inverter 312 can include a fifth transistor 318 and a sixth transistor 320. In an embodiment, the first and fifth thin film transistors 304 and 318 are PMOS transistors and the second, third, and sixth thin film transistors 306a, 306b, and 320 are NMOS transistors.

A source terminal of the first thin film transistor 304 is connected to a supply voltage V_{DD}. A gate terminal of the first thin film transistor 304 is connected to the second diode 302 for receiving the first detector signal V_{DET1}. A drain terminal of the second thin film transistor 306a is connected to a drain terminal of the first thin film transistor 304 to generate the first amplified detector signal V_{AMP1}. A gate terminal of the second thin film transistor 306a is connected to the second diode 302 for receiving the first detector signal V_{DET1} and a source terminal thereof is connected to ground. A source terminal of the third thin film transistor 306b is connected to the drain terminal of the first thin film transistor 304 and a drain terminal of the third thin film transistor 306b is connected to the gate terminal of the first thin film transistor 304. A gate terminal of the third thin film transistor 306b receives a second reference voltage signal V_{REF2}.

A gate terminal of the fourth thin film transistor 308 is connected to the drain terminal of the first thin film transistor 304 for receiving the first amplified detector signal V_{AMP1}. A drain terminal of the fourth thin film transistor 308 generates a second intermediate signal V_{INT2}, and a source terminal thereof is connected to ground. The delay circuit 310 is connected to the drain terminal of the fourth thin film transistor 308 for receiving the second intermediate signal V_{INT2} and generates a delayed version of the second intermediate signal (hereinafter referred to as “delayed second intermediate signal”) V_{DEL_INT2}. The delay circuit 310 includes a thin film resistor 314 and a thin film capacitor 316. A first end of the thin film resistor 314 is connected to the supply voltage V_{DD}. A first terminal of the thin film capacitor 316 is connected to a second end of the thin film resistor 314 for generating the delayed second intermediate signal V_{DEL_INT2}.

A gate terminal of the fifth thin film transistor 318 is connected to the second end of the thin film resistor 314 for receiving the delayed second intermediate signal V_{DEL_INT2}, and a source terminal thereof is connected to the supply voltage V_{DD}. A gate terminal of the sixth thin film transistor 320 is connected to the second end of the thin film resistor 314 for receiving the delayed second intermediate signal V_{DEL_INT2}. A drain terminal of the sixth thin film transistor 320 is connected to a drain terminal of the fifth thin film transistor 318 for generating the first shaped detector signal V_{SHP1}.

In operation, when the first sensor 124 activates the first detector signal V_{DET1}, the first preamplifier 116a amplifies and inverts the first detector signal V_{DET1}, and activates the first amplified detector signal V_{AMP1}. The fourth thin film transistor 308 activates the second intermediate signal V_{INT2}. The thin film capacitor 316 thus discharges to ground in a predetermined time period. The first thin film inverter 312 inverts and amplifies the delayed second intermediate signal V_{DEL_INT2} and generates the first shaped detector signal V_{SHP1} at logic high state. After the elapse of the predetermined time period, the first thin film inverter 312 generates the first shaped detector signal V_{SHP1} at logic low state.

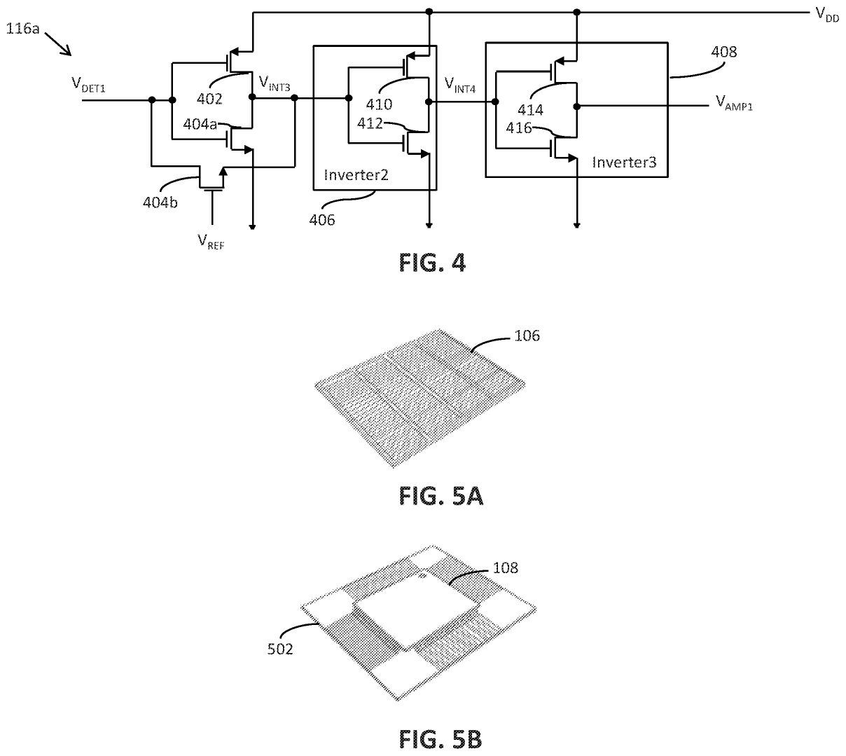

Referring now to FIG. 4, a schematic circuit diagram of the first preamplifier 116a in accordance with another embodiment of the present invention is shown. The first preamplifier 116a is implemented using the thin film technology. The first preamplifier 116a includes the seventh though ninth thin film transistors 402, 404a, and 404b and second and third thin film inverters 406 and 408. The seventh though ninth thin film transistors 402, 404a, and 404b are structurally and functionally similar to the first through third thin film transistors 304, 306a, and 306b. In an embodiment, the seventh thin film transistor 402 is a PMOS transistor and the eighth and ninth thin film transistors 404a and 404b are NMOS transistors. The second thin film inverter 406 includes tenth and eleventh thin film transistors 410 and 412. In an embodiment, the tenth thin film transistor 410 is a PMOS transistor and the eleventh thin film transistor 412 is an NMOS transistor. A drain terminal of the seventh thin film transistor 402 generates a third intermediate signal V_{INT3}. A source terminal of the tenth thin film transistor 410 is connected to the supply voltage V_{DD} and a gate terminal of the tenth thin film transistor 410 is connected to the drain terminal of the seventh thin film transistor 402 for receiving the third intermediate signal V_{INT3}. A gate terminal of the eleventh thin film transistor 412 is connected to the drain terminal of the seventh thin film transistor 402 for receiving the third intermediate signal V_{INT3}. A drain terminal of the eleventh thin film transistor 412 is connected to a drain terminal of the tenth thin film transistor 410 for generating a fourth intermediate signal V_{INT4} and a source terminal thereof is connected to ground.

The third thin film inverter 408 includes twelfth and thirteenth thin film transistors 414 and 416. In an embodiment, the twelfth thin film transistor 414 is a PMOS transistor and the thirteenth thin film transistor 416 is an NMOS transistor. A source terminal of the twelfth thin film transistor 414 is connected to the supply voltage V_{DD} and a gate terminal of the twelfth thin film transistor 414 is connected to the drain terminal of the tenth thin film transistor 410 for receiving the fourth intermediate signal V_{INT4}. A gate terminal of the thirteenth thin film transistor 416 is connected to a drain terminal of the tenth thin film transistor 410 for receiving the fourth intermediate signal V_{INT4}. A drain terminal of the thirteenth thin film transistor 416 is connected to a drain terminal of the twelfth thin film transistor 414 for generating the first amplified detector signal V_{AMP1} and a source terminal thereof is connected to ground.

Referring now to FIGS. 5A and 5B, a front view and a rear view of the radiation detector 102 in accordance with an embodiment of the present invention is shown. The radiation detector 102 includes the array of detectors 106, the IC 108, and a substrate 502.

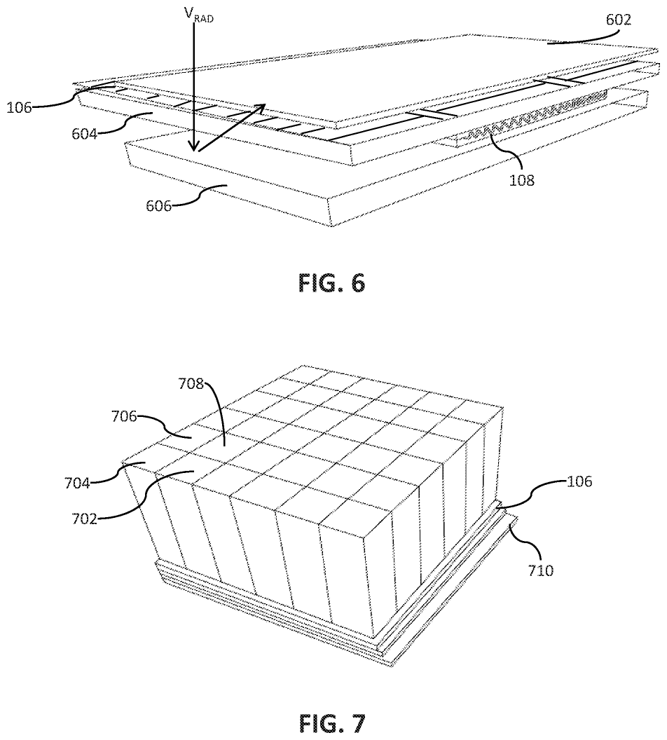

Referring now to FIG. 6, a perspective view of the radiation detector 102 in accordance with another embodiment of the present invention is shown. The radiation detector 102 includes a conversion layer 602, a printed circuit board 604, and a reflector 606. The radiation detector 102 further includes the array of detectors 106 and the IC 108. The reflector 606 receives the multiple radiations V_{RAD} and reflects the multiple radiations V_{RAD}. The reflected multiple radiations V_{RAD} are received by the conversion layer 602. In an embodiment, the reflector is a paraffin block. Thus, the efficiency of detecting the multiple radiations V_{RAD} increases by utilizing the reflector 606.

In yet another embodiment, when the array of detectors 106 are manufactured utilizing the thin film technology, the first detector 110 is stacked on top of the second detector 112, thereby increasing the efficiency of detecting the radiation V_{RAD} by the array of detectors 106. In an example, the radiation V_{RAD} is neutron radiation. It will be apparent to a person skilled in the art that in addition to the first detector 110, the third detector 114 may be stacked on top of the second detector 112, thereby further increasing the efficiency of detecting the radiations V_{RAD}.

Referring now to FIG. 7, a perspective view of the radiation detector 102 in accordance with another embodiment of the present invention is shown. The radiation detector 102 includes first through fourth conversion layers 702, 704, 706, 708, the array of detectors 106, and a thin film transistor (TFT) backplane 710. The TFT backplane 710 includes the array of preamplifiers 116 and the array of signal shaping circuits 118.

Thus, the radiation detector 102 is simple to design, cost-effective, and portable. Further, multiple detectors can be implemented in a single radiation detector 102, thereby increasing its resolution. The radiation detector 102 can be configured to detect a single (type of) radiation V_{RAD} as well as multiple (types of) radiation(s) V_{RAD}. The multiple detectors to detect a single type of radiation V_{RAD} provide a large area for detecting the radiations V_{RAD}. Further, the voltages required for operating the array of preamplifiers 116 and the array of signal shaping circuits 118 are low. Thus, the power consumed by the radiation detector 102 is low. Since the radiation detector 102 can be interfaced with smartphones, tablets, and personal computers, the radiation detector 102 does not require in-built circuits for processing the output signal V_{OUT} or displaying the type of radiation V_{RAD}. Further, the use of smartphones, tablets, and personal computers with the radiation detector 102 results in high-speed data manipulation of the output signal V_{OUT}, thereby achieving a faster processing of the output signal V_{OUT}. Moreover, the output signal V_{OUT} can be wirelessly transmitted from smartphones to several locations such as data centers for analytical use. The smartphone can be used for identifying a geo-location of a radiation source that emits the radiation V_{RAD}, thereby obtaining the source of the radiation V_{RAD}. The radiation detector 102 implemented using the thin film technology has very low sensitivity to false gamma-rays, thereby avoiding a false output signal V_{OUT}. Further, they can sustain very high temperatures.

The subject invention includes, but is not limited to, the following exemplified embodiments.

Embodiment 1. A system for simultaneously detecting a plurality of radiations, comprising:
an array of detectors for receiving the plurality of radiations and generating a corresponding plurality of detector signals, wherein a detector of the array of detectors generates a detector signal of the plurality of detector signals, the detector comprising:
at least one conversion layer for receiving the plurality of radiations and generating a conversion output signal corresponding to a radiation of the plurality of radiations, and
a sensor, connected to the at least one conversion layer, for receiving the conversion output signal and generating the detector signal; and
an integrated circuit, connected to the array of detectors, for receiving the plurality of detector signals and generating a plurality of output signals indicative of detecting the radiation, the integrated circuit comprising:
an array of preamplifiers for receiving the plurality of detector signals and generating a corresponding plurality of amplified detector signals, wherein a preamplifier of the array of preamplifiers is connected to the detector for receiving the detector signal and generating an amplified detector signal of the plurality of amplified detector signals; and
an array of signal shaping circuits, connected to the corresponding array of preamplifiers, for receiving the plurality of amplified detector signals and generating the corresponding plurality of output signals, wherein a signal shaping circuit of the array of signal shaping circuits is connected to the preamplifier for receiving the amplified detector signal and generating an output signal of the plurality of output signals, and wherein the array of detectors are implemented using at least one of a silicon technology and a thin film technology and the integrated circuit is implemented using at least one of a complementary metal oxide semiconductor (CMOS) technology and the thin film technology.

Embodiment 2. The system of embodiment 1, further comprising a reflector for reflecting the plurality of radiations to the array of detectors.

Embodiment 3. The system of any of embodiments 1-2, wherein the sensor is a charge sensor, and wherein the sensor comprises at least one of a PN diode and a PIN diode.

Embodiment 4. The system of any of embodiments embodiment 1-3, further comprising a processing unit, connected to the array of signal shaping circuits, for receiving the plurality of output signals and generating a processed output signal.

Embodiment 5. The system of any of embodiments 1-4, wherein the preamplifier comprises:
a first transistor having a source connected to a positive supply voltage and a gate connected to the detector for receiving the detector signal;
a second transistor having a gate connected to the detector for receiving the detector signal, a drain connected to a drain of the first transistor for generating the amplified detector signal, and a source connected to a negative supply voltage; and
a third transistor having a drain connected to the gate of the first transistor, a gate for receiving a reference voltage signal, and a source connected to the drain of the first transistor.

Embodiment 6. The system of any of embodiments 1-5, wherein the signal shaping circuit includes:
a first logic gate for receiving the output signal, and connected to the drain of the first transistor for receiving the amplified detector signal and generating an intermediate signal; and
a second logic gate for receiving a delayed version of the intermediate signal and generating the output signal.

Embodiment 7. The system of any of embodiments 1-6, wherein the sensor and the array of preamplifiers are fabricated using the thin film technology, and wherein the sensor includes a charge sensor.

Embodiment 8. The system of any of embodiments 1-7, wherein the signal shaping circuit includes:
a thin film transistor having a gate connected to the preamplifier for receiving the amplified detector signal, a drain for generating an intermediate signal, and a source connected to ground; and
a thin film inverter for receiving a delayed version of the intermediate signal, and generating the output signal.

Embodiment 9. A system for detecting a plurality of radiations, comprising:
an array of detectors for receiving the plurality of radiations and generating a corresponding plurality of detector signals,
   wherein a first detector of the array of detectors comprises:
at least one conversion layer for receiving the plurality of radiations and generating a conversion output signal corresponding to a first radiation of the plurality of radiations, and
a first sensor, connected to the at least one conversion layer, for receiving the conversion output signal and generating a first detector signal of the plurality of detector signals corresponding to the first radiation,
and wherein a second detector of the plurality of detectors includes a second sensor for receiving the plurality of radiations and generating a second detector signal of the plurality of detector signals corresponding to a second radiation of the plurality of radiations; and
an array of preamplifiers, connected to the array of detectors for receiving the plurality of detector signals and generating a corresponding plurality of amplified detector signals, wherein first and second preamplifiers of the array of preamplifiers are connected to the first and second detectors for receiving the first and second detector signals and generating first and second amplified detector signals of the plurality of amplified detector signals, respectively;
an array of signal shaping circuits, connected to the corresponding array of preamplifiers, for receiving the plurality of amplified detector signals and generating a corresponding plurality of shaped detector signals, wherein first and second signal shaping circuits of the array of signal shaping circuits are connected to the first and second preamplifiers for receiving the first and second amplified detector signals and generating first and second shaped detector signals of the plurality of shaped detector signals, respectively, wherein the array of detectors is implemented using at least one of a silicon technology and a thin film technology and the array of preamplifiers and the array of signal shaping circuits are implemented using at least one of a complementary metal oxide semiconductor (CMOS) technology and the thin film technology; and
a processing unit, connected to the array of signal shaping circuits, for receiving the plurality of shaped detector signals and generating an output signal, wherein the output signal is indicative of detecting at least one of the first and second radiations.

Embodiment 10. The system of embodiment 9, wherein the first radiation includes at least one a gamma radiation, a neutron radiation, and an X-ray radiation, and the second radiation includes at least one of an alpha radiation and a beta radiation.

Embodiment 11. The system of any of embodiments 9-10, wherein the at least one conversion layer is at least one of a neutron conversion layer, a gamma scintillator, and an X-ray scintillator.

Embodiment 12. The system of any of embodiments 9-11, further comprising a reflector for reflecting the plurality of radiations to the array of detectors.

Embodiment 13. The system of any of embodiments 9-12, wherein the first sensor is a charge sensor, and wherein the sensor comprises at least one of a PN diode and a PIN diode.

Embodiment 14. The system of any of embodiments 9-13, wherein the second sensor is a photon-sensitive sensor, and wherein the second sensor comprises at least one of a photosensor and a photoconductor.

Embodiment 15. The system of any of embodiments 9-14, wherein the processing unit includes at least one of a logic gate, a processor, and a microcontroller.

Embodiment 16. The system of any of embodiments 9-15, wherein the first preamplifier comprises:
a first transistor having a source connected to a positive supply voltage and a gate connected to the first detector for receiving the first detector signal;
a second transistor having a gate connected to the first detector for receiving the first detector signal, a drain connected to a drain of the first transistor for generating the first amplified detector signal, and a source connected to a negative supply voltage; and
a third transistor having a drain connected to the gate of the first transistor, a gate for receiving a reference voltage signal, and a source connected to the drain of the first transistor.

Embodiment 17. The system of any of embodiments 9-16, wherein the first signal shaping circuit includes:
a first logic gate for receiving the first shaped detector signal, and connected to the drain of the first transistor for receiving the first amplified detector signal and generating an intermediate signal; and
a second logic gate for receiving a delayed version of the intermediate signal and generating the first shaped detector signal.

Embodiment 18. The system of any of embodiments 9-17, wherein each of the first and second sensors include a thin film sensor, and wherein the first sensor is a charge sensor and the second sensor is a photon-sensitive sensor.

Embodiment 19. The system of any of embodiments 9-18, wherein the array of preamplifiers is fabricated using the thin film technology.

Embodiment 20. The system of any of embodiments 9-19, wherein the first signal shaping circuit includes:
a thin film transistor having a gate connected to the first preamplifier for receiving the first amplified detector signal, a drain for generating an intermediate signal, and a source connected to ground; and
a thin film inverter for receiving a delayed version of the intermediate signal, and generating the first shaped detector signal.

It will be understood by those with skill in the art that the same logical function may be performed by different arrangements of logic gates, or that logic circuits operate using either positive or negative logic signals. Therefore, variations in the arrangement of some of the logic gates described above should not be considered to depart from the scope of the present invention.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

What is claimed is:

1. A system for simultaneously detecting a plurality of radiations, comprising:
an array of detectors for receiving the plurality of radiations and generating a corresponding plurality of detector signals, wherein a detector of the array of detectors generates a detector signal of the plurality of detector signals, the detector comprising:
at least one conversion layer for receiving the plurality of radiations and generating a conversion output signal corresponding to a radiation of the plurality of radiations, and
a sensor, connected to the at least one conversion layer, for receiving the conversion output signal and generating the detector signal; and
an integrated circuit, connected to the array of detectors, for receiving the plurality of detector signals and generating a plurality of output signals indicative of detecting the radiation, the integrated circuit comprising:
an array of preamplifiers for receiving the plurality of detector signals and generating a corresponding plurality of amplified detector signals, wherein a preamplifier of the array of preamplifiers is connected to the detector for receiving the detector signal and generating an amplified detector signal of the plurality of amplified detector signals; and
an array of signal shaping circuits, connected to the corresponding array of preamplifiers, for receiving the plurality of amplified detector signals and generating the corresponding plurality of output signals, wherein a signal shaping circuit of the array of signal shaping circuits is connected to the preamplifier for receiving the amplified detector signal and generating an output signal of the plurality of output signals, and wherein the array of detectors are implemented using at least one of a silicon technology and a thin film technology and the integrated circuit is implemented using at least one of a complementary metal oxide semiconductor (CMOS) technology and the thin film technology.

2. The system of claim 1, further comprising a reflector for reflecting the plurality of radiations to the array of detectors.

3. The system of claim 1, wherein the sensor is a charge sensor, and wherein the sensor comprises at least one of a PN diode and a PIN diode.

4. The system of claim 1, further comprising a processing unit, connected to the array of signal shaping circuits, for receiving the plurality of output signals and generating a processed output signal.

5. The system of claim 1, wherein the preamplifier comprises:
a first transistor having a source connected to a positive supply voltage and a gate connected to the detector for receiving the detector signal;
a second transistor having a gate connected to the detector for receiving the detector signal, a drain connected to a drain of the first transistor for generating the amplified detector signal, and a source connected to a negative supply voltage; and
a third transistor having a drain connected to the gate of the first transistor, a gate for receiving a reference voltage signal, and a source connected to the drain of the first transistor.

6. The system of claim 5, wherein the signal shaping circuit includes:
a first logic gate for receiving the output signal, and connected to the drain of the first transistor for receiving the amplified detector signal and generating an intermediate signal; and
a second logic gate for receiving a delayed version of the intermediate signal and generating the output signal.

7. The system of claim 1, wherein the sensor and the array of preamplifiers are fabricated using the thin film technology, and wherein the sensor includes a charge sensor.

8. The system of claim 7, wherein the signal shaping circuit includes:
a thin film transistor having a gate connected to the preamplifier for receiving the amplified detector signal, a drain for generating an intermediate signal, and a source connected to ground; and
a thin film inverter for receiving a delayed version of the intermediate signal, and generating the output signal.

9. A system for detecting a plurality of radiations, comprising:
an array of detectors for receiving the plurality of radiations and generating a corresponding plurality of detector signals,
wherein a first detector of the array of detectors comprises:
at least one conversion layer for receiving the plurality of radiations and generating a conversion output signal corresponding to a first radiation of the plurality of radiations, and a first sensor, connected to the at least one conversion layer, for receiving the conversion output signal and generating a first detector signal of the plurality of detector signals corresponding to the first radiation, and wherein a second detector of the plurality of detectors includes a second sensor for receiving the plurality of radiations and generating a second detector signal of the plurality of detector signals corresponding to a second radiation of the plurality of radiations; and
an array of preamplifiers, connected to the array of detectors for receiving the plurality of detector signals and generating a corresponding plurality of amplified detector signals, wherein first and second preamplifiers of the array of preamplifiers are connected to the first and second detectors for receiving the first and second detector signals and generating first and second amplified detector signals of the plurality of amplified detector signals, respectively;
an array of signal shaping circuits, connected to the corresponding array of preamplifiers, for receiving the plurality of amplified detector signals and generating a corresponding plurality of shaped detector signals, wherein first and second signal shaping circuits of the array of signal shaping circuits are connected to the first and second preamplifiers for receiving the first and second amplified detector signals and generating first and second shaped detector signals of the plurality of shaped detector signals, respectively, wherein the array of detectors is implemented using at least one of a silicon technology and a thin film technology and the array of preamplifiers and the array of signal shaping circuits are implemented using at least one of a complementary metal oxide semiconductor (CMOS) technology and the thin film technology; and
a processing unit, connected to the array of signal shaping circuits, for receiving the plurality of shaped detector signals and generating an output signal, wherein the output signal is indicative of detecting at least one of the first and second radiations.

10. The system of claim 9, wherein the first radiation includes at least one a gamma radiation, a neutron radiation, and an X-ray radiation, and the second radiation includes at least one of an alpha radiation and a beta radiation.

11. The system of claim 9, wherein the at least one conversion layer is at least one of a neutron conversion layer, a gamma scintillator, and an X-ray scintillator.

12. The system of claim 9, further comprising a reflector for reflecting the plurality of radiations to the array of detectors.

13. The system of claim 9, wherein the first sensor is a charge sensor, and wherein the sensor comprises at least one of a PN diode and a PIN diode.

14. The system of claim 9, wherein the second sensor is a photon-sensitive sensor, and wherein the second sensor comprises at least one of a photosensor and a photoconductor.

15. The system of claim 9, wherein the processing unit includes at least one of a logic gate, a processor, and a microcontroller.

16. The system of claim 9, wherein the first preamplifier comprises:
a first transistor having a source connected to a positive supply voltage and a gate connected to the first detector for receiving the first detector signal;
a second transistor having a gate connected to the first detector for receiving the first detector signal, a drain connected to a drain of the first transistor for generating the first amplified detector signal, and a source connected to a negative supply voltage; and
a third transistor having a drain connected to the gate of the first transistor, a gate for receiving a reference voltage signal, and a source connected to the drain of the first transistor.

17. The system of claim 16, wherein the first signal shaping circuit includes:
a first logic gate for receiving the first shaped detector signal, and connected to the drain of the first transistor for receiving the first amplified detector signal and generating an intermediate signal; and
a second logic gate for receiving a delayed version of the intermediate signal and generating the first shaped detector signal.

18. The system of claim 9, wherein each of the first and second sensors include a thin film sensor, and wherein the first sensor is a charge sensor and the second sensor is a photon-sensitive sensor.

19. The system of claim 18, wherein the array of preamplifiers is fabricated using the thin film technology.

20. The system of claim 19, wherein the first signal shaping circuit includes:
a thin film transistor having a gate connected to the first preamplifier for receiving the first amplified detector signal, a drain for generating an intermediate signal, and a source connected to ground; and
a thin film inverter for receiving a delayed version of the intermediate signal, and generating the first shaped detector signal.
